(19) United States
(12) Patent Application Publication
(10) Pub. No.: US 2025/0253438 A1
(43) Pub. Date: Aug. 7, 2025

(54) FLUID EXPANSION TANK

(71) Applicant: MAHLE International GmbH, Stuttgart (DE)

(72) Inventors: Dietmar Wilhelm, Wiernsheim (DE); Michael Braunheim, Goeppingen (DE); Hans-Martin Ruppert, Ostfildren (DE); Ralf Zink, Stuttgart (DE); Stefan Jauss, Donzdorf (DE)

(21) Appl. No.: 19/043,401

(22) Filed: Jan. 31, 2025

(30) Foreign Application Priority Data
Feb. 1, 2024 (DE) 102024102848.3

(51) Int. Cl. H01M 10/6568; H01M 10/613; H01M 10/625

(52) U.S. Cl. CPC H01M 10/6568; H01M 10/613; H01M 10/625

(57) ABSTRACT

The invention relates to a fluid equalization tank with a receiving chamber and a wall, wherein the wall divides the receiving chamber into a plurality of subchambers. The subchambers are fluidically connected via openings in the wall.

### CROSS REFERENCE TO RELATED APPLICATION

This application claims priority to German Patent Application No. DE102024102848.3, filed on Feb. 1, 2024, the contents of which is hereby incorporated by reference in its entirety.

### TECHNICAL FIELD

The invention relates to a fluid equalization tank for equalizing a change in volume of a cooling fluid in a fluid circuit for immersion cooling of a battery of a vehicle.

### BACKGROUND

A battery of a vehicle can be immersion-cooled in a fluid circuit with a cooling fluid such as oil, for example. The fill level of the cooling fluid must be equalized due to a temperature-related change in volume. In order to realize this function, the fluid circuit usually comprises a fluid equalization tank. The excess amount of cooling fluid can be stored in the fluid equalization tank, at least temporarily. Usually, the fluid equalization tank is not completely filled, so that the cooling fluid can also move in the fluid equalization tank when the fluid equalization tank is moved. This results in unpleasant sloshing noises, which should be avoided.

### SUMMARY

The task of the invention is therefore to specify an improved or at least alternative embodiment for a fluid equalization tank of the generic type according to the present invention, in which the disadvantages described are overcome.

According to the invention, this task is solved with the features of independent claim(s). Advantageous embodiments are provided with the dependent claim(s).

The present invention is based on the general idea of providing inner walls in the fluid equalization tank, wherein a uniform flow through the fluid equalization tank is ensured via breaches in the inner walls.

The fluid equalization tank according to the invention is provided or designed for equalizing a change in volume of a cooling fluid in a fluid circuit for immersion cooling of a battery of a vehicle. The fluid equalization tank has at least one receiving chamber for receiving the cooling fluid and at least one wall. One of the walls is arranged in at least one of the receiving chambers and the receiving chamber is divided into at least two subchambers by the wall. The wall has at least one opening, wherein the adjacent subchambers of the receiving chamber are fluidically connected to each other via at least one of the openings. Conveniently, the opening can be located at the lowest point of at least one of the two subchambers fluidically connected by this opening in the case of the fluid equalization tank aligned for operation.

In the fluid equalization tank according to the invention, the sloshing of the cooling fluid in the receiving chamber can be prevented by the wall. In particular, the cooling fluid can be divided between the subchambers of the receiving chamber, thereby reducing the intensity of the sloshing noise. The cooling fluid can flow freely between the subchambers through the openings in the wall, so that the cooling fluid is always available at an outlet of the fluid equalization tank for flowing out into the fluid circuit.

In one possible embodiment, at least one of the openings in the wall can be formed by a slot. In the fluid equalization tank, which is aligned for operation, the slot in the wall can extend from above to the lowest point of at least one of the two subchambers fluidically connected by this slot. The cooling fluid can flow particularly easily and quickly between the subchambers through the slot and the uniform flow through the fluid equalization tank can be achieved more easily. The fact that the slot extends to the lowest point of one of the two subchambers also ensures that the cooling fluid does not remain in any of the subchambers. This prevents water from accumulating in the individual subchambers and ensures that the fluid equalization tank is completely emptied.

In addition, it may be provided that a bead is formed on both edges of the wall delimiting the slot. In particular, the bead can extend over the entire length of the slot. The bead can be used to stabilize or stiffen the slot and thus also the wall.

In one possible embodiment, the fluid equalization tank can have a housing and the housing can delimit the receiving chamber to the outside. The wall can be formed separately from the housing and connected to the housing in a material-locking manner, preferably welded.

This makes it particularly easy to manufacture the fluid equalization tank.

In one possible embodiment, the fluid equalization tank can have a housing with an upper part and a lower part. The receiving chamber can then be formed in some areas in the upper part and in some areas in the lower part. The wall can have an upper wall section arranged in the upper part and a lower wall section arranged in the lower part. The upper wall section of the wall and the lower wall section of the wall can be supported against each other so that the individual subchambers are formed in the upper part in some areas and in the lower part in others. This can simplify the manufacture of the fluid equalization tank. Furthermore, the receiving chamber can thus be completely divided into the subchambers so that the cooling fluid is distributed across the individual subchambers and is not located in a common volume at each fill level of the cooling fluid in the fluid equalization tank.

The upper part of the housing and the lower part of the housing can be formed separately from each other and connected to each other in a material-locking manner, preferably welded.

The upper wall section of the wall and the lower wall section of the wall can be formed separately from each other and connected to each other in a material-locking manner, preferably welded. This can simplify the manufacture of the housing and the wall on the one hand and securely connect the housing and the wall on the other.

If the wall has at least one of the slots described above, at least one of the slits can have an upper slot section formed in the upper wall section of the wall and a lower slot section formed in the lower wall section of the wall. The upper slot section of the slot and the lower slot section of the slot may be offset relative to each other. In other words, the slot can be interrupted or discontinuous. This can ensure a sufficiently high strength of the fluid equalization tank and, in particular, increase the lateral component rigidity of the fluid equalization tank.

The terms “top” and “bottom” used here and below refer to the fluid equalization tank aligned for operation. The “upper” elements are arranged above the “lower” elements in the fluid equalization tank, which is aligned for operation.

Advantageously, each subchambers of the receiving chamber can be fluidically connected to all adjacent subchambers. This makes it particularly easy to achieve a uniform flow through the fluid equalization tank. It is also conceivable that the neighboring subchambers of the receiving chamber are fluidically connected to each other exclusively via at least one of the openings. It is also conceivable that the receiving chamber is completely divided into the individual subchambers. It is also conceivable that the wall divides the receiving chamber into a total of six or a total of nine subchambers. It is also conceivable that all subchambers of the receiving chamber have an identical shape and/or an identical volume and/or an identical cross-section. It is also conceivable that at least one of the subchambers of the receiving chamber is filled with an open-pored foam material, at least in some areas. Due to its structure, the open-pored foam allows the cooling fluid to flow between the subchambers, but advantageously prevents sloshing within the subchamber.

In one possible embodiment, the fluid equalization tank may have exactly two receiving chambers. The first receiving chamber can be designed to receive the cooling fluid from the fluid circuit and the second receiving chamber can be designed to receive the excess cooling fluid from the first receiving chamber. The fluid equalization tank can then have an overflow channel, wherein the first receiving chamber and the second receiving chamber are fluidically connected to each other exclusively via the overflow channel. The fluid equalization tank can also have exactly two walls. The first receiving chamber can then be divided into at least two subchambers by the first wall and the second receiving chamber can be divided into at least two subchambers by the second wall. The first receiving chamber can have an inlet for the cooling fluid to flow in from the fluid circuit and an outlet for the cooling fluid to flow out into the fluid circuit. The inlet and the outlet can open fluidically into one and the same subchamber of the receiving chamber. In this case, the outlet can be arranged at the lowest point of the first receiving chamber in one of the subchambers in the fluid equalization tank aligned for operation.

Further important features and advantages of the invention are apparent from the dependent claims, from the drawings and from the associated description of the figures with reference to the drawings.

It is understood that the above-mentioned features and those yet to be explained below can be used not only in the combination indicated in each case, but also in other combinations or on their own, without deviating from the scope of the present invention.

Preferred exemplary embodiments of the invention are shown in the drawings by way of example and will be explained in more detail in the following description, wherein identical reference signs refer to identical or similar or functionally identical elements.

### BRIEF DESCRIPTION OF THE DRAWING

It shows, schematically in each case:

FIG. 1 is a view of a fluid equalization tank according to the invention in a first embodiment;

FIGS. 2 and 3 are sectional views of the fluid equalization tank according to the invention in the first embodiment;

FIG. 4 and FIG. 5 are views of the fluid equalization tank according to the invention in a second embodiment;

FIG. 6 is a view of a lower part of a housing of the fluid equalization tank according to the invention in the second embodiment; and

FIG. 7 is a view of an upper part of the housing of the fluid equalization tank according to the invention in the second embodiment.

### DETAILED DESCRIPTION

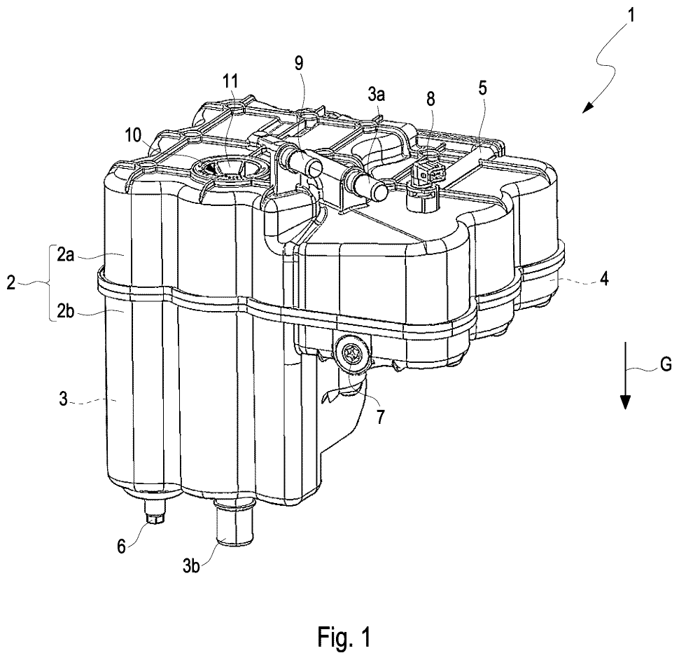

FIG. 1 shows a view of a fluid equalization tank 1 according to the invention in a first embodiment. The fluid equalization tank 1 is designed or intended to equalize a change in volume of a cooling fluid in a fluid circuit for immersion cooling of a vehicle battery. In FIG. 1, the fluid equalization tank 1 is aligned for operation with respect to the gravitational force G.

The fluid equalization tank 1 has a housing 2 with an upper part 2a and a lower part 2b, which are connected to each other in a fluid-tight manner, for example by welding. The fluid equalization tank 1 comprises a first receiving chamber 3 and a second receiving chamber 4, which are fluidically connected to each other via an overflow channel 5. The overflow channel 5 is formed such that the excess cooling fluid can flow from the first receiving chamber 3 into the second receiving chamber 4 and cannot flow back. This allows the excess cooling fluid, which is caused by a change in volume due to temperature and/or ageing, to be safely stored in the second receiving chamber 4. The first receiving chamber 3, the second receiving chamber 4 and the overflow channel 5 are formed in the housing 2. The housing 2 can be made of plastic, for example.

The first receiving chamber 3 has an inlet 3a leading into the receiving chamber 3 to the outside and an outlet 3b leading out of the first receiving chamber 3. Via the inlet 3a and the outlet 3b, the first receiving chamber 3 of the fluid equalization tank 1 is integrated into the fluid circuit. For this purpose, the inlet 3a and the outlet 3b can be fluidically connected to other components of the fluid circuit. The fluid circuit and the other components of the fluid circuit are not part of the present invention. The cooling fluid can then flow from the fluid circuit into the first receiving chamber 3 or fluid expansion tank 1 via the inlet 3a, and the cooling fluid can then flow out of the first receiving chamber 3 or fluid equalization tank 1 into the fluid circuit via the outlet 3b. In the fluid equalization tank 1 aligned for operation, outlet 3b is located centrally and appropriately at the lowest point of the first receiving chamber 3.

The fluid tank 1 also has a water drain opening 6 that leads from the first receiving chamber 3 to the outside. The water collected in the first receiving chamber 3 can be drained via the water drain opening 6. When the fluid equalization tank 1 is aligned for operation, the water drain opening 6 is located at the lowest point of the first receiving chamber 3, as intended.

The fluid equalization tank 1 also has an outlet opening 7 leading out of the second receiving chamber 4 to the outside. The outlet opening 7 is located at the lowest point of the second receiving chamber 4 when the fluid equalization tank 1 is aligned for operation.

Furthermore, the fluid equalization tank 1 comprises a level-measuring sensor 8 that detects the fill level of the excess cooling fluid in the second receiving chamber 4. When the second receiving chamber 4 is full, the user can be informed by a signal from the level measuring sensor 8 and the excess cooling fluid can be manually directed out of the second receiving chamber 4 or fluid equalization tank 1 via the outlet opening 7.

Furthermore, the fluid equalization tank 1 has a ventilation duct 9 that leads from the first receiving chamber 3 to the outside. The first receiving chamber 3 can be connected in an air-conducting manner to an air equalization tank via the ventilation duct 9, so that pressure differences caused by different fill levels of the cooling fluid in the first receiving chamber 3 can be equalized. The air equalization tank is not part of the present invention.

The fluid equalization tank 1 also has a screw plug 10 and an opening 11. The opening 11 leads from the first receiving chamber 3 to the outside and is closed by the screw plug 10. The fluid equalization tank 1 and thus the fluid circuit can be filled with the cooling fluid via the opening 11.

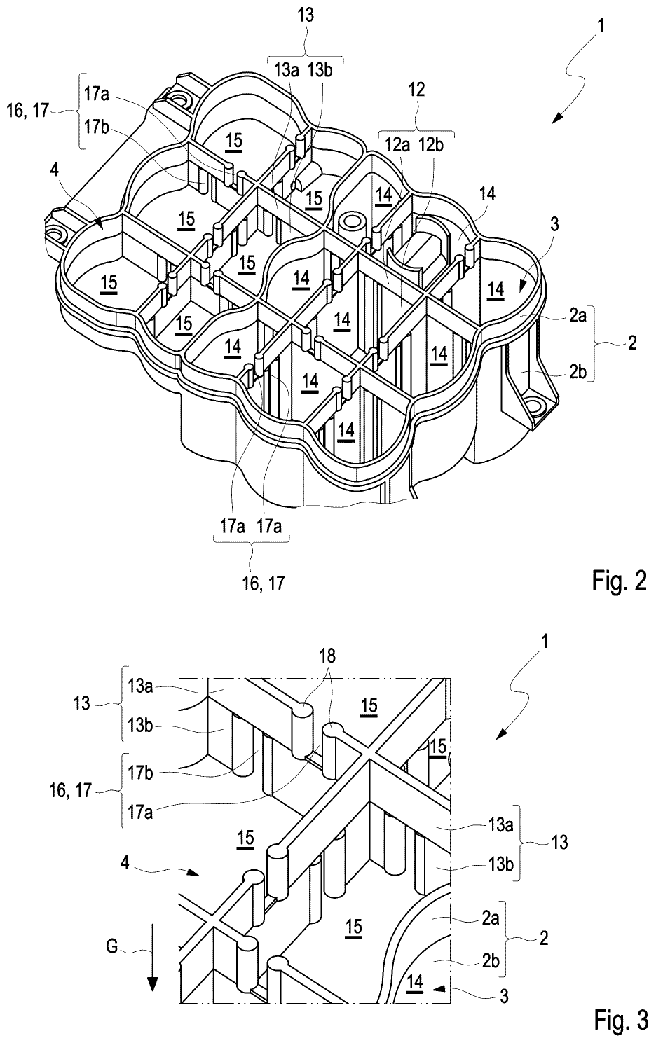

FIG. 2 shows a sectional view and FIG. 3 shows an enlarged sectional view of the fluid equalization tank 1 according to the invention in the first embodiment. As can be seen in FIG. 2 and FIG. 3, the fluid equalization tank 1 has a first wall 12 and a second wall 13. The first wall 12 is arranged in the first receiving space 3 and divides the first receiving chamber 3 into a plurality of subchambers 14, in this case nine. The second wall 13 is arranged in the second receiving chamber 4 and divides the second receiving chamber 4 into a plurality of subchambers 15, in this case six. The walls 12 and 13 have several openings 16, via which the individual subchambers 14 and 15 are fluidically connected to each other. In the first embodiment of the fluid equalization tank 1, the openings 16 are formed as slots 17.

In the fluid equalization tank 1 aligned for operation, the slots 17 are aligned vertically with respect to the gravitational force G and pass through from top to bottom over the entire height of the walls 12 and 13. Beads 18 are formed at the edges of the walls 12 and 13, which delimit the individual slots 17. The beads 18 stabilize the respective slot 17 and thereby stiffen the walls 12 and 13.

The walls 12 and 13 and the slots 17 are formed in some areas in the upper part 2a of the housing 2 and in some areas in the lower part 2b of the housing. Accordingly, the wall 12 comprises an upper wall section 12a in the upper part 2a of the housing 2 and a lower wall section 12b in the lower part 2b of the housing 2. Similarly, the wall 13 comprises an upper wall section 13a in the upper part 2a of the housing 2 and a lower wall section 13b in the lower part 2b of the housing 2. The wall sections 12a and 12b and 13a and 13b are supported against each other and can be welded together, for example. The slots 17 each comprise an upper slot section 17a and a lower slot section 17b. The slot sections 17a and 17b of the individual slot 17 are formed offset relative to each other, so that the slot 17 is not continuous or is interrupted. This allows the walls 12 and 13 and overall the fluid equalization tank 1 to be stabilized or stiffened.

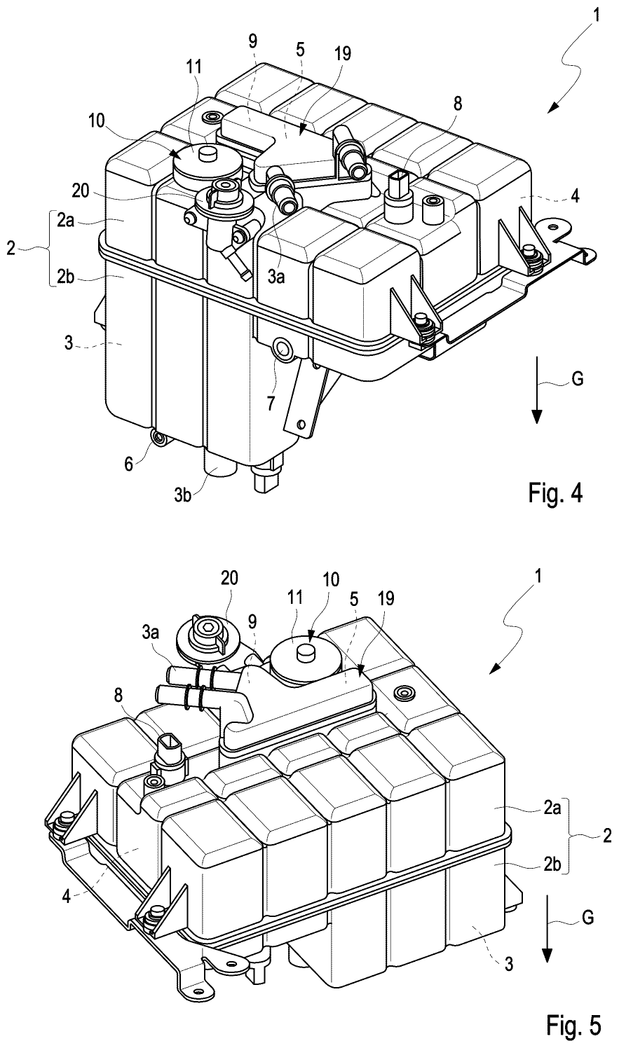

FIG. 4 and FIG. 5 show views of the fluid equalization tank 1 according to the invention in a second embodiment. In contrast to the first embodiment, the fluid equalization tank 1 here has the housing 2 and a channel cover 19. The overflow channel 5 and the ventilation channel 9 are formed between the housing 2 or the upper part 2a of the housing 2 and the channel cover 19. In addition, a shut-off valve 20 is shown in FIG. 4 and FIG. 5.

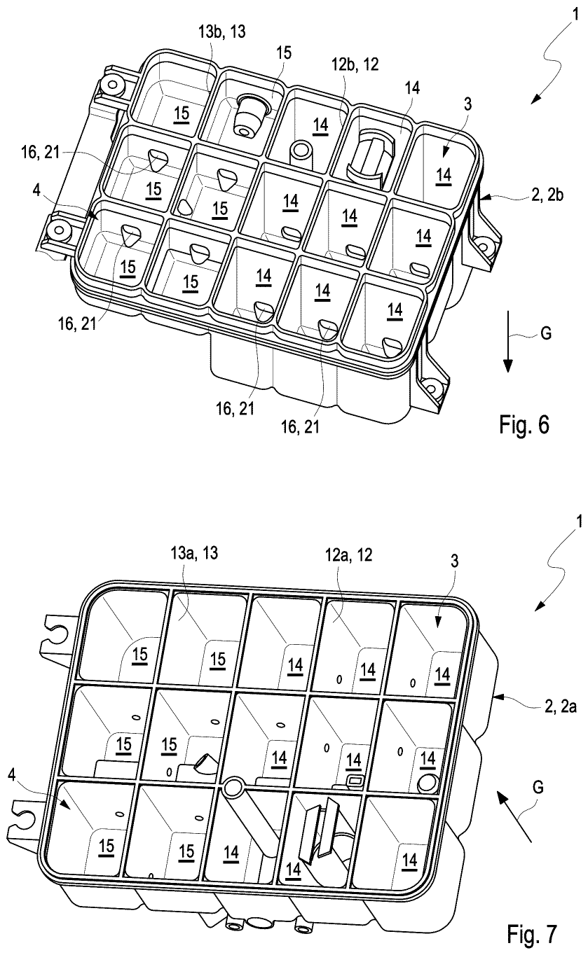

FIG. 6 shows a view of the lower part 2b of the housing 2 and FIG. 7 shows a view of the upper part 2a of the housing 2 of the fluid equalization tank 1 according to the invention in the second embodiment. In contrast to the first embodiment, the openings 16 in the walls 12 and 13 are formed here as through-holes 21. The holes 21 are formed in each case at the lowest point of the subchambers 14 and 15. Otherwise, the two embodiments are the same.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “various embodiments,” “with embodiments,” “in embodiments,” or “an embodiment,” or the like, means that a particular feature, structure, or characteristic described in connection with the example/embodiment is included in at least one embodiment. Thus, appearances of the phrases “examples, “in examples,” “with examples,” “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first element could be termed a second element, and, similarly, a second element could be termed a first element, without departing from the scope of the various described embodiments. The first element and the second element are both elements, but they are not the same element.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the phrase at least one of successive elements separated by the word “and” (e.g., “at least one of A and B”) is to be interpreted the same as the term “and/or” and as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g.” and “such as” in the specification are to be construed broadly and are used to provide non-limiting examples of embodiments of the disclosure, and the disclosure is not limited to such examples.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

All matter contained in the above description or shown in the accompanying drawings shall be interpreted as illustrative only and not limiting. Changes in detail or structure may be made without departing from the present disclosure.

What is claimed is:

1. A fluid equalization tank for equalizing a change in volume of a cooling fluid in a fluid circuit for the immersion cooling of a battery of a vehicle, the fluid equalization tank comprising:
at least one receiving chamber for receiving the cooling fluid; and
at least one wall,
wherein the at least one wall is arranged in the at least one receiving chamber and the at least one receiving chamber is divided by the at least one wall into at least two subchambers adjacent to each other, and
wherein the at least one wall has at least one opening and the subchambers of the at least one receiving chamber are fluidically connected to each other via the at least one opening.

2. The fluid equalization tank according to claim 1, wherein:
the at least one opening of the least one wall includes a slot, and
when the fluid equalization tank is aligned for operation, the slot in the least one wall extends from above to a lowest point of at least one of the two subchambers that are fluidically connected by the slot.

3. The fluid equalization tank according to claim 2, wherein a bead is disposed on both edges of the least one wall defining the slot.

4. The fluid equalization tank according to claim 2, wherein:
the fluid equalization tank has a housing with an upper part and a lower part and the at least one receiving chamber is disposed in the upper part and in the lower part,
the at least one wall has an upper wall section arranged in the upper part and a lower wall section arranged in the lower part, and
the upper wall section of the at least one wall and the lower wall section of the at least one wall are supported against one another, so that the subchambers are disposed in the upper part and in the lower part.

5. The fluid equalization tank according to claim 4, wherein:
the upper part of the housing and the lower part of the housing are separate components joined together by welding, and/or
the upper wall section of the at least one wall and the lower wall section of the at least one wall are separate components joined together by welding.

6. The fluid equalization tank according to claim 4, wherein:
the slot of the at least one wall has an upper slot section disposed in the upper wall section of the at least one wall and a lower slot section disposed in the lower wall section of the least one wall, and
the upper slot section of the slot and the lower slot section of the slot are offset relative to each other.

7. The fluid equalization tank according to claim 4, wherein:
the housing delimits the at least one receiving chamber to the outside, and
the at least one wall and the housing are separate components joined by welding.

8. The fluid equalization tank according to claim 1, wherein at least one of the subchambers of the at least one receiving chamber is filled with an open-pored foam.

9. A fluid equalization tank comprising:
a receiving chamber; and
a wall dividing the receiving chamber into a plurality of subchambers,
wherein each of the subchambers is fluidically connected to all adjacent subchambers.

10. The fluid equalization tank according to claim 9, wherein each of the subchambers of the receiving chamber has the same shape.

11. The fluid equalization tank according to claim 9, wherein each of the subchambers of the receiving chamber has the same volume.

12. The fluid equalization tank according to claim 9, wherein each of the subchambers of the receiving chamber has the same cross-sectional shape.

13. The fluid equalization tank according to claim 9, wherein the wall divides the receiving chamber into a total of six or a total of nine subchambers.

14. The fluid equalization tank according to claim 9, wherein the receiving chamber is completely divided into individual subchambers.

15. The fluid equalization tank according to claim 9, wherein the adjacent subchambers of the receiving chamber are connected to each other fluidically via at least one opening.

16. A fluid equalization tank comprising:
a first receiving chamber and a second receiving chamber, wherein the first receiving chamber receives cooling fluid from a fluid circuit and the second receiving chamber receives excess cooling fluid from the first receiving chamber;
an overflow channel, wherein the first receiving chamber and the second receiving chamber are fluidically connected to each other solely via the overflow channel; and
a first wall and a second wall, wherein the first receiving chamber is divided by the first wall into at least two subchambers and the second receiving chamber is divided by the second wall into at least two subchambers.

17. The fluid equalization tank according to claim 16, wherein the first receiving chamber is divided by the first wall into nine subchambers.

18. The fluid equalization tank according to claim 17, wherein the first wall includes a plurality of openings.

19. The fluid equalization tank according to claim 16, wherein the second receiving chamber is divided by the second wall into six subchambers.

20. The fluid equalization tank according to claim 19, wherein the second wall includes a plurality of openings.
